(19) United States
(12) Patent Application Publication
(10) Pub. No.: US 2026/0045404 A1
(43) Pub. Date: Feb. 12, 2026

(54) MULTI-PHASE INDUCTOR STRUCTURE FOR BOARD MOUNT POWER MACRO REPLICATION

(71) Applicant: Cisco Technology, Inc., San Jose, CA (US)

(72) Inventors: Joel Richard Goergen, Soulsbyville, CA (US); Elizabeth Kochuparambil, Morgan Hill, CA (US); Kameron Rose Hurst, Sonora, CA (US); Alpesh Umakant Bhobe, Sunnyvale, CA (US); David Nozadze, San Jose, CA (US); Jonathan D. Austin, San Jose, CA (US)

(21) Appl. No.: 18/796,649

(22) Filed: Aug. 7, 2024

(51) Int. Cl. H01F 27/29; H01F 27/02; H01F 27/28

(52) U.S. Cl. CPC H01F 27/292; H01F 27/027; H01F 27/2828

(57) ABSTRACT

A multi-phase inductor package that includes at least one set or cluster of inductors between a first plate and a second plate. The inductors in the at least one cluster are positioned in an intra-cluster arrangement such that a mutual magnetic flux density between the inductors in the at least one cluster is substantially equal. This arrangement may be extended to a plurality of clusters of inductors in an arrangement such that a mutual magnetic flux density between adjacent clusters of the plurality of clusters is substantially equal.

### TECHNICAL FIELD

The present disclosure relates to power supply devices and methods.

### BACKGROUND

Board mount power supplies are used to convert electrical power from a source into a format suitable for powering a load, such as a DC-to-DC converter. A board mount power supply is configured to physically and mechanically connect to a printed circuit board. Inductors are used in such power supplies to achieve a desired phase or multiple phases. In the case of a multi-phase power supply, the multiple inductors are arranged to have a desired mutual inductance.

### BRIEF DESCRIPTION OF THE DRAWINGS

FIG. 1 is an exploded diagram of a multi-phase inductor package that comprises a cluster of inductors, according to an example embodiment.

FIG. 2 is a diagram of a multi-phase inductor package that comprises a plurality of clusters of inductors, according to an example embodiment.

FIG. 3 is an exploded diagram of a multi-phase inductor package comprising a plurality of clusters, with the depth of inductors into a top plate and/or bottom plate, adjusted to control mutual magnetic flux density between clusters of inductors, according to an example embodiment.

FIG. 4 is an exploded diagram of a bottom plate and a board of a multi-phase inductor package, where the bottom plate and board cooperate to set the depth of inductors in the bottom plate, according to an example embodiment.

FIG. 5 is a schematic diagram representing a plurality of clusters of inductors in a layout arrangement according to the embodiments presented herein to achieve equal mutual magnetic flux density between clusters.

FIG. 6 is a schematic diagram of a multi-phase board mount power system that provides 3-phase output power, according to an example embodiment.

FIG. 7A is a schematic diagram of a multi-phase board mount power system that provides 15-phase output power, according to an example embodiment.

FIG. 7B is an exploded view of a multi-phase inductor package that forms a part of the multi-phase board mount power system shown in FIG. 7A, according to an example embodiment.

FIG. 8 is an exploded view of a multi-phase inductor package according to an example embodiment.

FIG. 9 is a flow chart of a method for generating multi-phase power using a multi-phase inductor package, according to an example embodiment.

FIG. 10 is a block diagram of a device that is configured to employ a multi-phase power supply using the inductor package arrangements described above in connection with FIG. 1-6, 7A. 7B, 8 and 9.

### DETAILED DESCRIPTION

### Overview

Briefly, a multi-phase inductor package is provided that includes at least one cluster of inductors between a first plate and a second plate. The inductors in the at least one cluster of inductors are positioned in an intra-cluster arrangement such that a mutual magnetic flux density between the inductors in the at least one cluster of inductors is substantially equal. This arrangement may be extended to a plurality of clusters of inductors in an arrangement such that a mutual magnetic flux density between adjacent clusters of the plurality of clusters is substantially equal.

In another form, a board mount power supply is provided. The board mount power supply comprises a multi-phase inductor package including at least one cluster of inductors between a first plate and a second plate. The inductors in the at least one cluster of inductors are positioned in an intra-cluster arrangement such that a mutual magnetic flux density between the inductors in the at least one cluster of inductors is substantially equal. The board mount power supply further includes a multi-phase controller configured to output a plurality of current signals at multiple different phases to the at least one cluster of inductors to produce multi-phase power at an output of the multi-phase inductor package.

Further still, in another example, a board mount power supply comprising a multi-phase inductor package including a plurality of clusters of inductors positioned between a first plate and a second plate. Each cluster of the plurality of clusters comprises a plurality of inductors in an intra-cluster arrangement such that a mutual magnetic flux density between the inductors within a cluster is substantially equal. The plurality of clusters are positioned in an inter-cluster arrangement such that a mutual flux density between adjacent clusters of the plurality of clusters is substantially equal. The board mount power supply further includes a plurality of multi-phase controllers, each for an associated cluster of the plurality of clusters. Each multi-phase controller is configured to output a plurality of current signals at multiple different phases to the associated cluster to produce multi-phase power at an output of the multi-phase inductor package.

### Example Embodiments

In existing multi-phase board mount power supplies, the inductors are positioned in a (linear) serial arrangement to couple mutual inductance. For a dynamically loaded system of integrated circuit power loading, there is room to improve magnetic flux density flow resulting from mutual series-based coupling.

Structural arrangements for inductors in a multi-phase power supply are provided that improve and equalize the magnetic flux density and thus improve a mutually induced filter response. These arrangements create an equivalent flux density path between all ferrite core inductors, allowing for equivalent mutual inductance and better filtering response for each phase to be produced by the power supply.

Embodiments are presented herein for a multi-phase inductor package that comprises at least one cluster of inductors between a first plate and a second plate. The inductors are positioned/laid out in an intra-cluster arrangement (within the cluster) such that a mutual magnetic flux density between inductors is substantially equal.

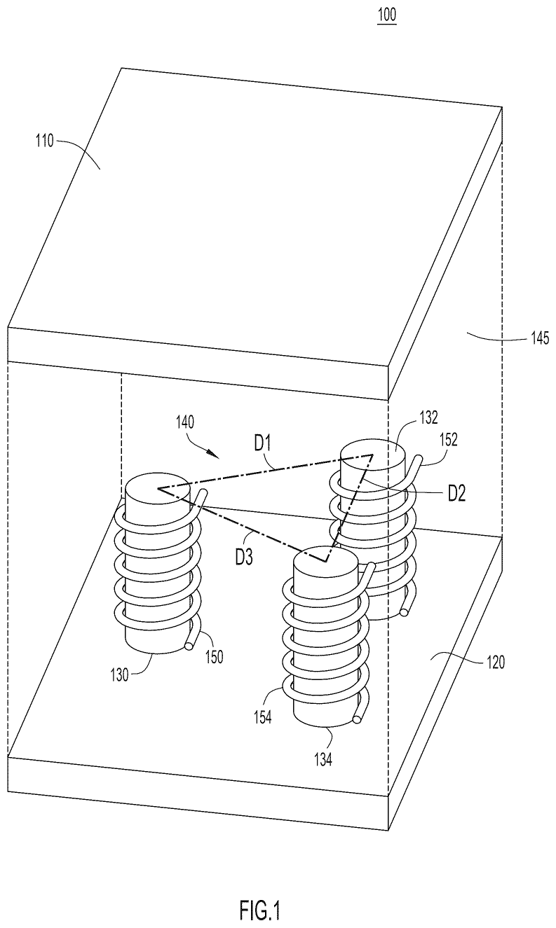

Referring first to FIG. 1, a diagram is shown of a three-phase (3-phase) inductor package 100 according to the concepts presented herein. The inductor package 100 comprises a first (e.g., top) plate 110 and a second (e.g., bottom) plate 120 and three inductors 130, 132 and 134. The inductors 130, 132 and 134 form a set or cluster 140 and are laid out in an arrangement such that a mutual magnetic flux density between inductors in the at least one cluster is substantially equal. For example, the inductors 130, 132 and 134 are positioned in a triangular layout arrangement in a space 145 between the first plate 110 and the second plate 120. There is a winding 150, 152 and 154 around each inductor 130, 132, and 134, respectively. The inductors 130, 132 and 134 may be pillars or monuments made of suitable magnetic material, such as ferrite. Though not shown as such, it is to be understood that the first plate 110 fits seals over the inductors 130, 132 and 134, against the second plate 120. While the first plate 110 and the second plate 120 are shown as having a rectangular shape, this is not meant to be limiting, and they could take on other shapes (circular, etc.) as may be desired for a particular application.

The inductors 130, 132 and 134 may be substantially equally spaced apart from each other. In addition, the cluster 140 of inductors may be positioned at a central location of the package evenly spaced away from the side edges of the plates 110 and 120, and not with inductors along the sides or at the corners of the plates.

As a result of the triangular layout arrangement, the mutual magnetic flux densities between respective inductors are substantially equal. That is, the mutual magnetic flux density D between inductor 130 and inductor 132 is substantially equal to the mutual magnetic flux density D₂ between inductor 132 and inductor 134, which is substantially equal to the mutual magnetic flux density D₃ between inductor 134 and inductor 130, where “substantially equal” is meant to include arrangements where the mutual magnetic flux density between inductors is exactly/precisely equal as well arrangements where the mutual magnetic flux density between inductors may be slightly different. That is, D₁=D₂=D₃. This mutual magnetic flux density relationship cannot be achieved if the inductors were laid out in a row.

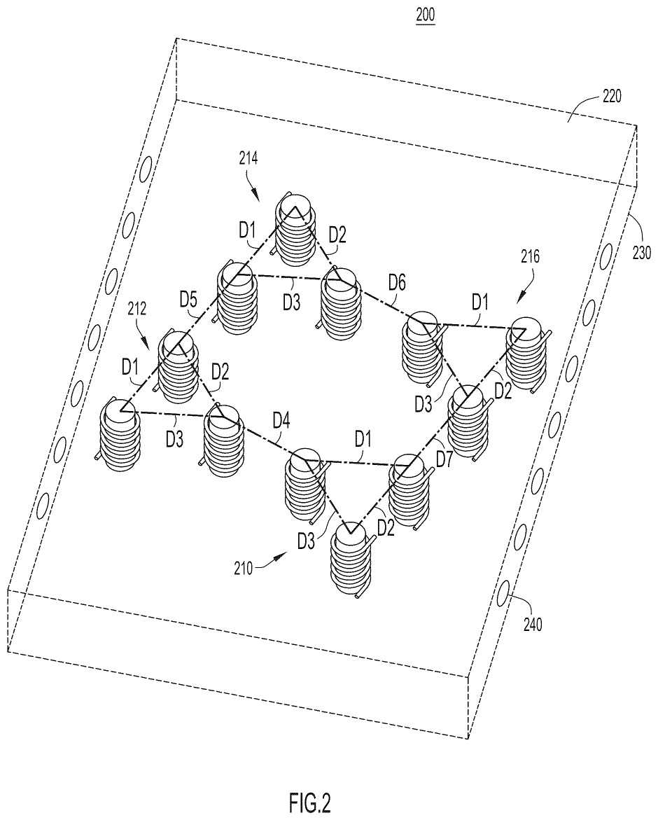

FIG. 2 shows an extension of the inductor layout arrangement shown in FIG. 1, to support even more phases. The inductor package 200 of FIG. 2 comprises a plurality of sets or clusters of inductors, and each set or cluster comprises three inductors in a triangular layout arrangement. In other words, the inductor package 200 comprises multiple instances of the cluster shown in FIG. 1. For example, to support 12 phases, the inductor package 200 has four sets or clusters 210, 212, 214 and 216, each comprising three inductors. For simplicity and to avoid overcrowding of the figure, reference numerals are not assigned to the individual inductors in each of the clusters 210, 212, 214 and 216, and likewise the windings for each inductor are not specifically referenced. The clusters 210, 212, 214 and 216 are positioned between plates 220 and 230. The plates 220 and 230 may be sealed over and around the clusters 210, 212, 214 and 216 but with openings 240 to allow for wiring access to the inductors. The number of clusters in an inductor package and the number inductors in a cluster can vary (beyond 3 inductors). The clusters 210, 212, 214 and 216 (each with three inductors) can support 12 phases, but five clusters could support 15 phases, and so on. The clusters 210, 212, 214 and 216 may be positioned in a generally circular arrangement around a central portion of the package between the plates 220 and 230. As a result of the triangular arrangement of inductors within each cluster (the intra-cluster arrangement of inductors) and the positioning of the clusters themselves (the inter-cluster arrangement), the mutual magnetic flux density between inductors and then between clusters is substantially equal. That is, D₁=D₂=D₃=D₄=D₅=D₆=D7. Said another way, the plurality of clusters 210, 212, 214 and 216 are positioned in an inter-cluster arrangement such that a mutual flux density between adjacent clusters of the plurality of clusters is substantially equal.

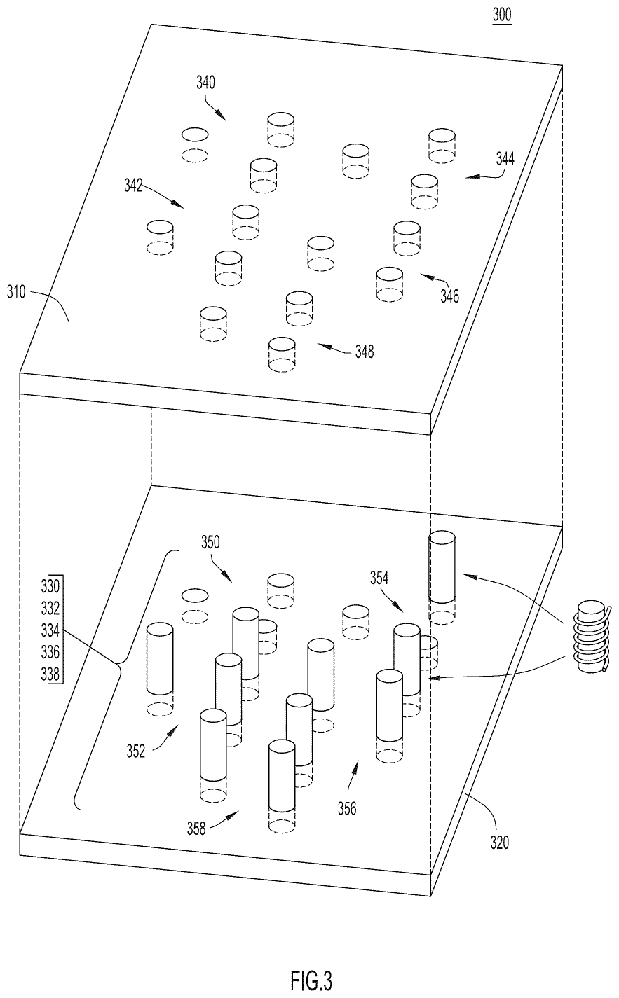

The flux density and field intensity associated with inductors (and hence the mutual magnetic flux density between inductors and inductor clusters) can be further adjusted by the depth of the inductor monuments into a top and/or a bottom plate). To this end, reference is now made to FIG. 3. FIG. 3 shows an inductor package 300 comprising a first (top) plate 310 and a second (bottom) plate 320, and a plurality of clusters 330, 332, 334, 336 and 338 of inductors arranged between the first and second plates 310 and 320. Each of the clusters 330, 332, 334, 336 and 338 may comprise three inductors (not specifically labeled and shown without the windings on each inductor for simplicity) positioned in a triangular arrangement like that of FIG. 1, and the clusters may be positioned in between the first and second plates 310 and 320 in a manner similar to that of FIG. 3 in order to achieve equal mutual flux density between clusters.

In the first plate 310 and/or second plate 320 there are holes aligned with the positions of the inductors in each cluster. For example, there are hole clusters 340, 342, 344, 346 and 348 in the first plate 310 and hole clusters 350, 352, 354, 356 and 358 in the second plate 320 that receive the (top and bottom portions) of the inductors of the clusters 330, 332, 334, 336 and 338.

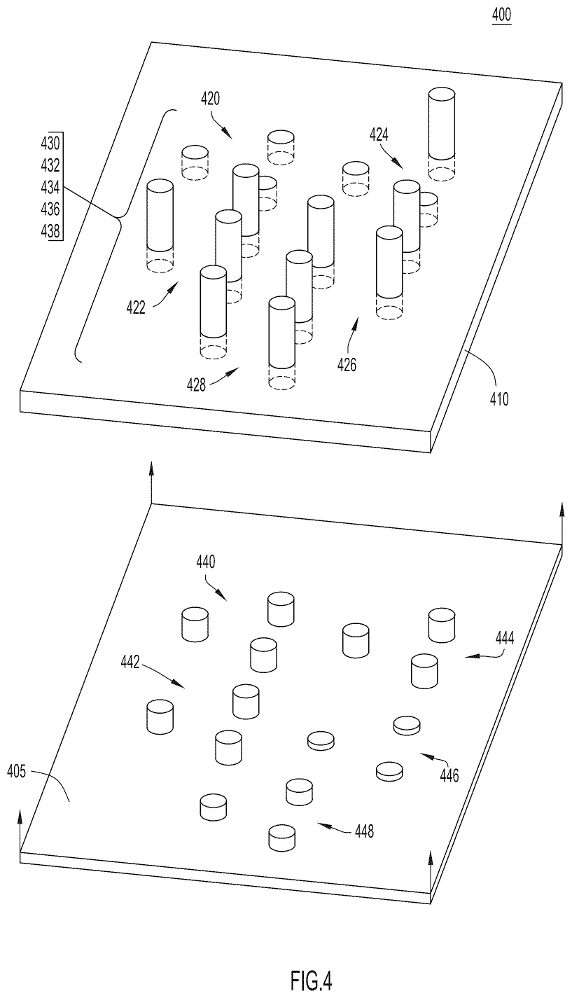

Turning now to FIG. 4, an inductor package 400 is now described to facilitate the depth control concepts depicted in FIG. 3. To set the depth of inductor monuments into the plates of an inductor package, a board 405 is provided that has a plurality of bumps that are positioned to fit into a plurality of holes of at least one of the plates of an inductor package. For example, FIG. 4 shows a bottom plate 410 of an inductor package. The bottom plate 410 has a plurality of hole clusters 420, 422, 424, 426 and 428 that receive inductors of clusters 430, 432, 434, 436 and 438, respectively. The board 405 has a plurality of clusters 440, 442, 444, 446 and 448 of bumps that are aligned to fit into corresponding ones of the hole clusters 420, 422, 424, 426 and 428 in the bottom plate 410. The bumps in the clusters 440, 442, 444, 446 and 448 have heights that extend into the holes of the hole clusters 420, 422, 424, 426 and 428 that, as a result, set depts of inductors of the plurality of clusters 430, 432, 434, 436 and 438, into the bottom plate 410, to desired depths in order to control the mutual flux density between the plurality of clusters 430, 432, 434, 436 and 438 of inductors. For example, FIG. 4 shows that the heights of the bumps in cluster 446 are lower than the heights of the bumps in cluster 448. Moreover, the heights of the bumps in cluster 440, 442 and 444 are greater than the heights of the bumps in clusters 446 and 448. Consequently, the inductors in cluster 426 will sit deeper into the bottom plate 410 than the inductors of cluster 428, and even still further deeper into the bottom plate than the inductors of clusters 420, 422 and 424.

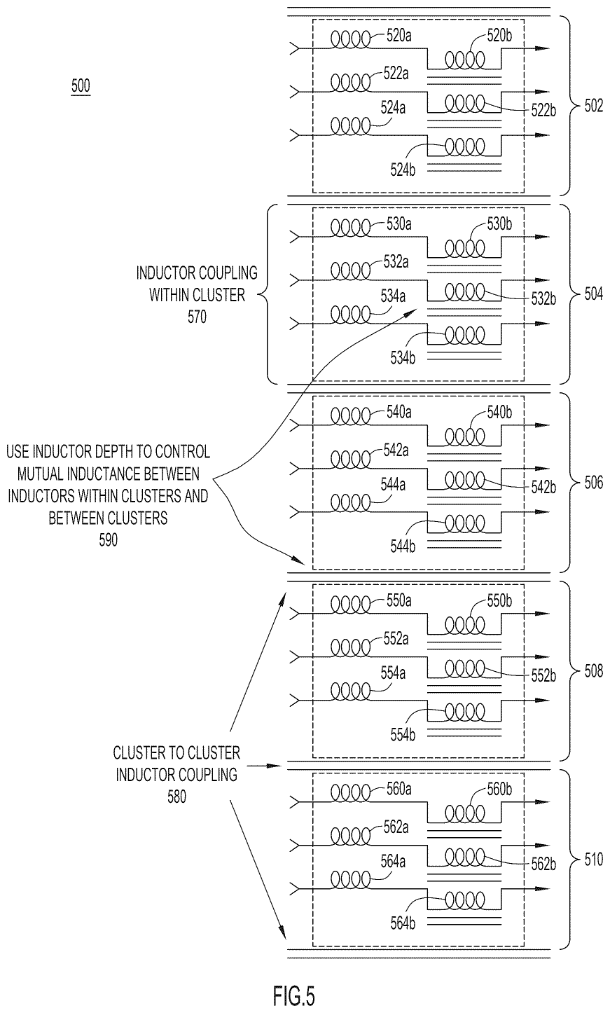

Reference is now made to FIG. 5, which shows a schematic diagram 500 representing a plurality of clusters of inductors arranged according to the embodiments presented herein. In particular, the schematic diagram 500 shows clusters 502, 504, 506, 508 and 510, and each of the clusters 502, 504, 506, 508 and 510 comprises 3 inductors each shown as comprising two inductors in series (referred to as an “inductor series pair”), with one inductor mutually coupled to an inductor of an adjacent inductor series pair. That is, cluster 502 comprises inductor series pairs 520a/520b, 522a/522b and 524a/524b. Inductor 520b is shown mutually coupled to inductor 522b, and inductor 522b is shown mutually coupled to inductor 524b. However, it is to be understood that inductor 520b is also mutually coupled to inductor 524b, though it is not possible to show this in a two-dimensional drawing. The same is true for cluster 504 that comprises inductor series pairs 530a/530b, 532a/532b and 534a/534b; for cluster 506 that comprises inductor series pairs 540a/540b, 542a/542b and 544a/544b; for cluster 508 that comprises inductor series pairs 550a/550b, 552a/552b and 554a/554b; and for cluster 510 that comprises inductor series pairs 560a/560b, 562a/562b and 564a/564b. Thus, within each cluster, there is inductor-to-inductor coupling, as shown at reference numeral 570. Moreover, between clusters, there is inductor coupling, as shown at reference numeral 580. Again, as FIG. 5 can only show two-dimensional interactions, it is to be understood that with the layout arrangements shown in FIG. 2-4, there is mutual inductor coupling between physically adjacent clusters that is substantially equal throughout the clusters. Further still, as shown at reference numeral 590, the inductor depth (into the top plate and/or bottom plate) may be used to control mutual inductance between inductors within clusters and between clusters.

Magnetic flux density has wave tendencies to it. The transfer of the flux density “wave” from one medium to the next (even if equal) is impacted by the material volume the wave contacts. The innovations presented herein achieve an equal flux density, and when the depth of the ferrite core inductors are changed in the ferrite plates, then the flux density transference is reduced based on the contact area and contact position.

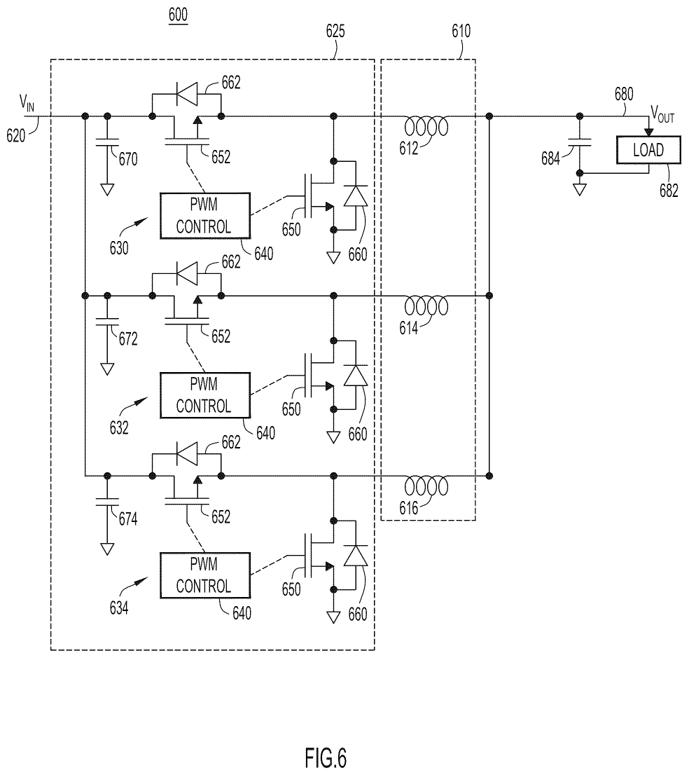

Turning now to FIG. 6, a schematic diagram is shown of a multi-phase board mount power system 600 that provides 3-phase output power, as an example. The power system 600 includes a 3-phase inductor package 610 that employs the layout arrangement shown in FIG. 1 and comprises three inductors 612, 614 and 616. The power system further includes an input 620 to receive an input power (V_{IN}) and a multi-phase controller 625 that includes three instances of phase switch circuitry 630, 632 and 634 for inductors 612, 614 and 616, respectively. The phase switch circuitry 630, 632 and 634 each comprises a pulse width modulation (PWM) control circuit 640 coupled to switches 650 and 652, each of which has a diode 660 and 662, respectively, coupled across it to ensure current flow in the desired direction into the associated inductor. The switches 650 and 652 may be field effect transistor (FET) switches. There is also a capacitor 670, 672 and 674 coupled between the input and ground for each of the phase switched paths. The 3-inductor package 610 is coupled to output 680 (V_{OUT}) to provide 3-phase output power to a load 682 across a capacitor 684.

In operation of the power system 600, the PWM control circuit 640 of each phase switch circuitry 630, 632 and 634, uses switches 652 and 650 to pull the input inductance voltage at the associated inductor 612, 614 and 616, respectively, to either Vin or ground, or some resistance value to soften or sharpen the edge transitions. The voltage through the inductor package 610 is dependent on the current flowing through it. By controlling the flux density impact from inductors 612, 614 and 616, the voltage changes across inductors 614 and 616 are already aligned with that of inductor 612 such that the required current flow through inductors 614 and 616 to maintain the output voltage is, as a result, significantly less. The common flux density impact across all power supply phases significantly lowers the total current, and thereby raises switching power supply efficiency.

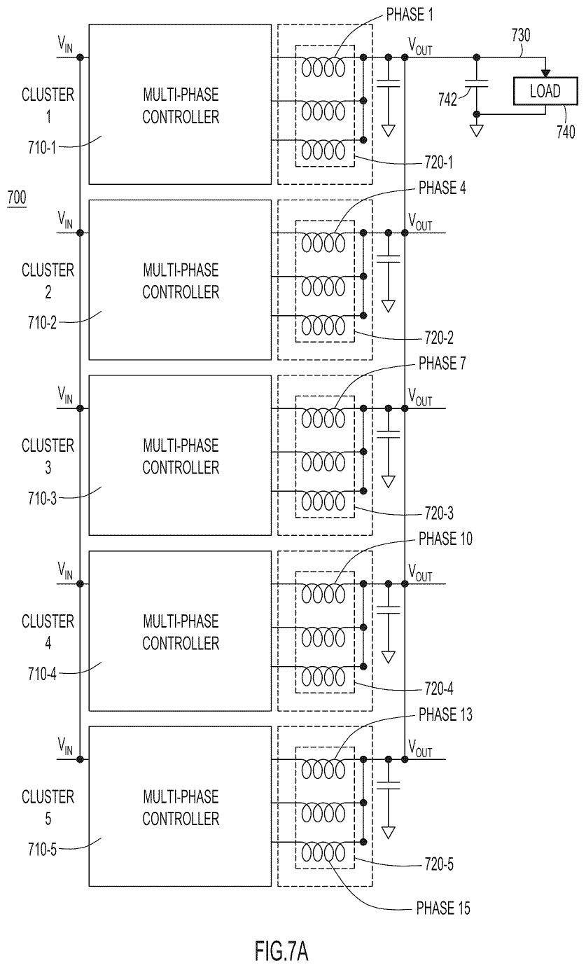

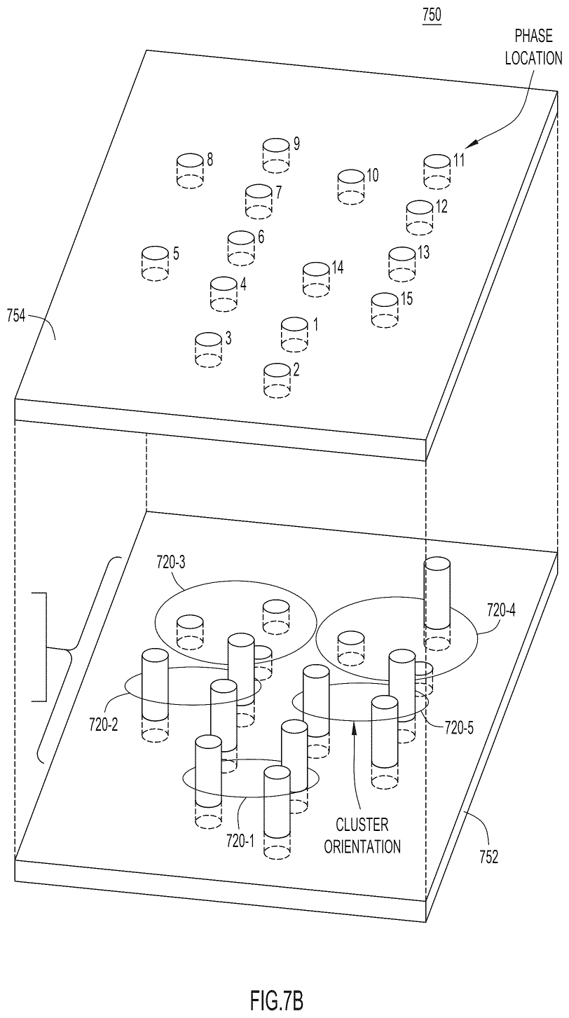

FIG. 7A is a schematic diagram of a multi-phase board mount power system 700 that is an extension of the power system 600 shown in FIG. 6 and is configured to provide 15 phases of power. FIG. 7B illustrates an inductor cluster layout/orientation for an inductor package used in the multi-phase board mount power system 700. The multi-phase board mount power system 700 comprises five instances of a multi-phase controller, one for each cluster (or set) of inductors. Thus, there is a multi-phase controller 710-1 for cluster 1 (associated with phases 1, 2 and 3), a multi-phase controller 710-2 for cluster 2 (associated with phases 4, 5 and 6), a multi-phase controller 710-3 for cluster 3 (associated with phases 7, 8 and 9), a multi-phase controller 710-4 for cluster 4 (associated with phases 10, 11 and 12), and a multi-phase controller 710-5 for cluster 5 (associated with phases 13, 14 and 15). Each multi-phase controller 710-1 to 710-5 may take the form of the multi-phase controller 625 shown in FIG. 6. The five clusters of inductors are shown at 720-1, 720-2, 720-3, 720-4 and 720-5, respectively. The power system 700 provides 15 phases of output power at output 730 (V_{OUT}) to load 740 and across capacitor 742.

FIG. 7B shows an exploded diagram of an inductor package 750 that may be used in the power system 700 shown in FIG. 7A. The inductor package 750 includes the plurality of clusters 720-1 through 720-5 of inductors positioned as shown between a first plate 752 and a second plate 754. For illustration purposes, the location of the individual inductors and their associated phases in the clusters 720-1 through 720-5 are shown labeled (1 through 15) on the top of the second plate 754.

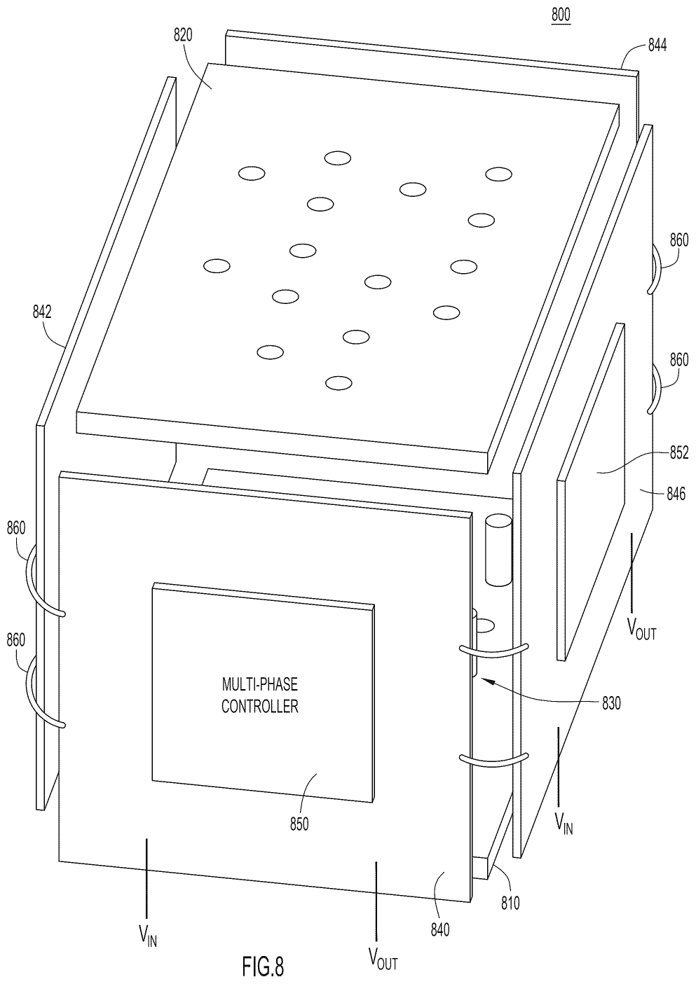

FIG. 8 is an exploded view of a multi-phase inductor package 800 according to an example embodiment. The inductor package 800 includes a first (bottom) plate 810 and a second (top) plate 820. The clusters 830 of inductors are positioned between the first plate 810 and second plate 820. Printed circuit boards (PCBs) 840, 842, 844 and 846 are provided that are transverse to sides of the first plate 810 and the second plate 820 so as to enclose and “wrap” around the sides of the inductor package 800. The circuitry (FET switches, capacitors, and PWM controllers) of the multi-phase controllers used to drive the inductors may be mounted on either or both sides of the PCBs 840, 842, 844 and 846. Thus, FIG. 8 shows multi-phase controllers 850 and 852 mounted to PCB 840 and PCB 842, and though not visible in FIG. 8, it is to be understood that the PCBs 842 and 844 may also have a multi-phase controller mounted to them (on either or both sides). Input (V_{IN}) to and output (V_{OUT}) from, the multi-phase controllers may be at the PCBs at various locations of the PCBs around the inductor package 800, as shown in the figure. In addition, wire connections 860 may be provided between sides of the PCBs to tie power rails and controls across the PCBs.

Thus FIG. 8 shows a plurality of PCBs 840, 842, 844 and 846 transverse and attached to sides of the first plate 810 and the second plate 820 so as to enclose around the multi-phase inductor package 800. One or more of a plurality of multi-phase controllers are mounted to one or more of the plurality of PCBs 840, 842, 844 and 846. It may be useful in same arrangements to have two or more (or all) multi-phase controllers mounted to a given one of the PCBs 840, 842, 844 and 846.

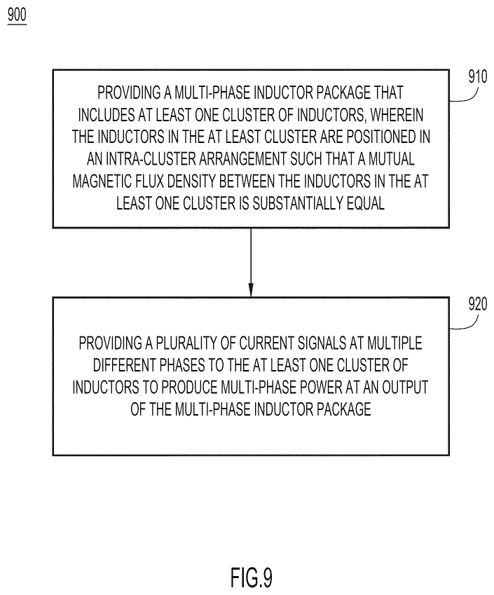

FIG. 9 illustrates a flow depicting a method 900 according to an example embodiment. The method 900 includes, at step 910, providing a multi-phase inductor package that includes at least one cluster of inductors, wherein the inductors in the at least cluster are positioned in an intra-cluster arrangement such that a mutual magnetic flux density between the inductors in the at least one cluster is substantially equal. At step 920, the method includes providing a plurality of current signals at multiple different phases to the at least one cluster of inductors to produce multi-phase power at an output of the multi-phase inductor package.

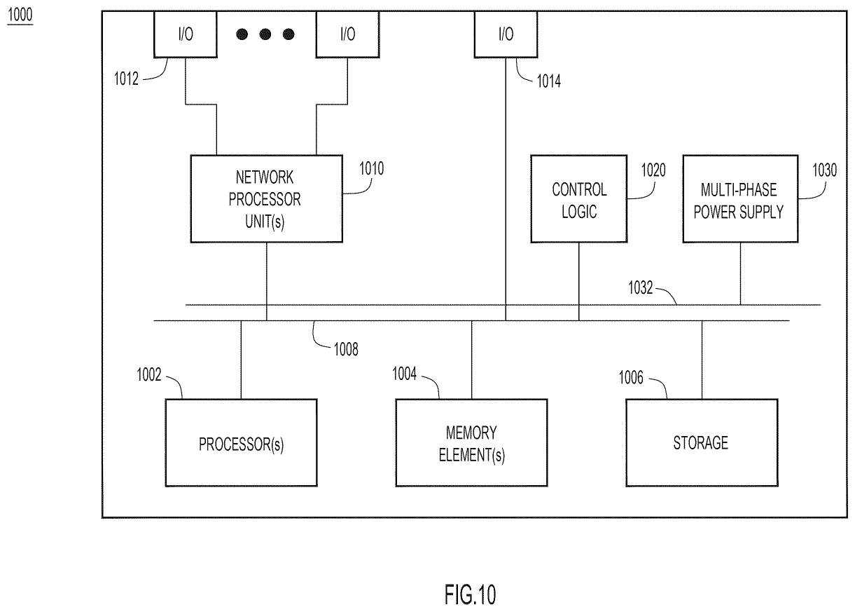

Referring to FIG. 10, FIG. 10 illustrates a hardware block diagram of a device 1000 that may employ a multi-phase power supply using the inductor package arrangements described above in connection with FIG. 1-6, 7A, 7B, 8 and 9. The device 1000 may be a computing or networking device or apparatus.

In at least one embodiment, the device 1000 may be any apparatus that may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for device 1000 can overlap in any manner and are not limited to the specific allocation of instructions and/or operations described herein. A board mounted multi-phase power supply 1030 may be provided to provide power to the various components of the device 1000 via power bus 1032. The multi-phase power supply 1030 may take on any of the configurations and arrangements described above in connection with FIG. 1-6, 7A, 7B, 8 and 9.

In at least one embodiment, processor(s) 1002 is/are at least one hardware processor configured to execute various tasks, operations and/or functions for device 1000 as described herein according to software and/or instructions configured for device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with device 1000, and/or logic configured for memory element(s) 1004 and/or storage 1006. For example, any logic described herein (e.g., control logic 1020) can, in various embodiments, be stored for device 1000 using any combination of memory element(s) 1004 and/or storage 1006. Note that in some embodiments, storage 1006 can be consolidated with memory element(s) 1004 (or vice versa), or can overlap/exist in any other suitable manner.

In at least one embodiment, bus 1008 can be configured as an interface that enables one or more elements of device 1000 to communicate in order to exchange information and/or data. Bus 1008 can be implemented with any architecture designed for passing control, data and/or information between processors, memory elements/storage, peripheral devices, and/or any other hardware and/or software components that may be configured for device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between device 1000 and other systems, entities, etc., via network I/O interface(s) 1012 (wired and/or wireless) to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to device 1000. For example, I/O interface(s) 1014 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In summary, the techniques described herein relate to an apparatus including: a multi-phase inductor package including at least one cluster of inductors of inductors between a first plate and a second plate, wherein inductors in the at least one cluster of inductors are positioned in an intra-cluster arrangement such that a mutual magnetic flux density between the inductors in the at least one cluster of inductors is substantially equal.

In some examples, the at least one cluster of inductors includes three inductors in a triangular arrangement.

In some examples, the three inductors are substantially equally spaced apart from each other.

In some examples, the at least one cluster of inductors is positioned in a central area of the first plate and the second plate spaced from sides and corners from the first plate and the second plate.

In some examples, the apparatus may further include a plurality of clusters of inductors between the first plate and the second plate, wherein the plurality of clusters are positioned in an inter-cluster arrangement such that a mutual flux density between adjacent clusters of the plurality of clusters is substantially equal.

In some examples, inductors in at least one cluster of the plurality of clusters of inductors are set to a particular depth into one or both of the first plate and the second plate, wherein the particular depth of inductors of the at least one cluster is different than a depth into one or both of the first plate and the second plate of inductors of other clusters of the plurality of clusters.

In some examples, at least one of the first plate and the second plate includes a plurality of holes positioned at locations corresponding to positions of inductors for the plurality of clusters.

In some examples, the apparatus further includes a board having a plurality of bumps that are positioned to fit into the plurality of holes of at least one of the first plate and the second plate, and wherein the plurality of bumps have heights that set depths of inductors of the plurality of clusters to desired depths into at least one of the first plate and the second plate.

In some examples, the techniques described herein relate to a board mount power supply including: a multi-phase inductor package including at least one cluster of inductors between a first plate and a second plate, wherein inductors in the at least one cluster of inductors are positioned in an intra-cluster arrangement such that a mutual magnetic flux density between the inductors in the at least one cluster of inductors is substantially equal; and a multi-phase controller configured to output a plurality of current signals at multiple different phases to the at least one cluster of inductors to produce multi-phase power at an output of the multi-phase inductor package

In some examples, the techniques described herein relate to a board mount power supply, wherein the at least one cluster of inductors includes three inductors in a triangular arrangement, and wherein the three inductors are equally space apart from each other.

In some examples, the techniques described herein relate to a board mount power supply, further including a plurality of clusters of inductors between the first plate and the second plate, wherein the plurality of clusters are positioned in an inter-cluster arrangement such that a mutual flux density between adjacent clusters of the plurality of clusters is substantially equal.

In some examples, the techniques described herein relate to a board mount power supply, wherein inductors in at least one cluster of the plurality of clusters of inductors are set to a particular depth into one or both of the first plate and the second plate, wherein the particular depth of inductors of the at least one cluster is different than a depth into one or both of the first plate and the second plate of inductors of other clusters of the plurality of clusters.

In some examples, the techniques described herein relate to a board mount power supply, wherein at least one of the first plate and the second plate includes a plurality of holes positioned at locations corresponding to positions of inductors for the plurality of clusters.

In some examples, the techniques described herein relate to a board mount power supply, and further including a board having a plurality of bumps that are positioned to fit into the plurality of holes of at least one of the first plate and the second plate, and wherein the plurality of bumps have heights that set depths of inductors of the plurality of clusters to desired depths into at least one of the first plate and the second plate.

In some examples, the techniques described herein relate to a board mount power supply including: a multi-phase inductor package including a plurality of clusters of inductors positioned between a first plate and a second plate, wherein each cluster of the plurality of clusters comprises a plurality of inductors in an intra-cluster arrangement such that a mutual magnetic flux density between the inductors within a cluster is substantially equal, and the plurality of clusters are positioned in an inter-cluster arrangement such that a mutual flux density between adjacent clusters of the plurality of clusters is substantially equal; and a plurality of multi-phase controllers, each for an associated cluster of the plurality of clusters, each multi-phase controller configured to output a plurality of current signals at multiple different phases to the associated cluster to produce multi-phase power at an output of the multi-phase inductor package.

In some examples, the techniques described herein relate to a board mount power supply, wherein each cluster of the plurality of clusters includes three inductors in a triangular arrangement, wherein the three inductors are substantially equally spaced apart from each other.

In some examples, the techniques described herein relate to a board mount power supply, wherein inductors in at least one cluster of the plurality of clusters of inductors are set to a particular depth into one or both of the first plate and the second plate, wherein the particular depth of inductors of the at least one cluster is different than a depth into one or both of the first plate and the second plate of inductors of other clusters of the plurality of clusters.

In some examples, the techniques described herein relate to a board mount power supply, wherein at least one of the first plate and the second plate includes a plurality of holes positioned at locations corresponding to positions of inductors for the plurality of clusters.

In some examples, the techniques described herein relate to a board mount power supply, and further including a board having a plurality of bumps that are positioned to fit into the plurality of holes of at least one of the first plate and the second plate, and wherein the plurality of bumps have heights that set depths of inductors of the plurality of clusters to desired depths into at least one of the first plate and the second plate.

In some examples, the board mount power supply further includes a plurality of printed circuit boards transverse and attached to sides of the first plate and the second plate so as to enclose around the multi-phase inductor package, and wherein one or more of the plurality of multi-phase controllers are mounted to one or more of the plurality of printed circuit boards. In addition, there may be wire connections between adjacent printed circuit boards of the plurality of printed circuit boards, the wire connections configured tie power rails and controls across the plurality of printed circuit boards.

In some examples, the techniques described herein relate to a method including: providing a multi-phase inductor package that includes at least one cluster of inductors, wherein the inductors in the at least cluster are positioned in an intra-cluster arrangement such that a mutual magnetic flux density between the inductors in the at least one cluster is substantially equal; and providing a plurality of current signals at multiple different phases to the at least one cluster of inductors to produce multi-phase power at an output of the multi-phase inductor package.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. An apparatus comprising:
a multi-phase inductor package including at least one cluster of inductors between a first plate and a second plate, wherein inductors in the at least one cluster of inductors are positioned in an intra-cluster arrangement such that a mutual magnetic flux density between the inductors in the at least one cluster of inductors is substantially equal.

2. The apparatus of claim 1, wherein the at least one cluster of inductors comprises three inductors in a triangular arrangement.

3. The apparatus of claim 2, wherein the three inductors are substantially equally spaced apart from each other.

4. The apparatus of claim 1, wherein the at least one cluster of inductors is positioned in a central area of the first plate and the second plate spaced from sides and corners from the first plate and the second plate.

5. The apparatus of claim 1, further comprising a plurality of clusters of inductors between the first plate and the second plate, wherein the plurality of clusters are positioned in an inter-cluster arrangement such that a mutual flux density between adjacent clusters of the plurality of clusters is substantially equal.

6. The apparatus of claim 5, wherein inductors in at least one cluster of the plurality of clusters of inductors are set to a particular depth into one or both of the first plate and the second plate, wherein the particular depth of inductors of the at least one cluster is different than a depth into one or both of the first plate and the second plate of inductors of other clusters of the plurality of clusters.

7. The apparatus of claim 6, wherein at least one of the first plate and the second plate comprises a plurality of holes positioned at locations corresponding to positions of inductors for the plurality of clusters.

8. The apparatus of claim 7, and further comprising a board having a plurality of bumps that are positioned to fit into the plurality of holes of at least one of the first plate and the second plate, and wherein the plurality of bumps have heights that set depths of inductors of the plurality of clusters to desired depths into at least one of the first plate and the second plate.

9. A board mount power supply comprising:
a multi-phase inductor package including at least one cluster of inductors between a first plate and a second plate, wherein inductors in the at least one cluster of inductors are positioned in an intra-cluster arrangement such that a mutual magnetic flux density between the inductors in the at least one cluster of inductors is substantially equal; and
a multi-phase controller configured to output a plurality of current signals at multiple different phases to the at least one cluster of inductors to produce multi-phase power at an output of the multi-phase inductor package.

10. The board mount power supply of claim 9, wherein the at least one cluster of inductors comprises three inductors in a triangular arrangement, and wherein the three inductors are equally space apart from each other.

11. The board mount power supply of claim 9, further comprising a plurality of clusters of inductors between the first plate and the second plate, wherein the plurality of clusters are positioned in an inter-cluster arrangement such that a mutual flux density between adjacent clusters of the plurality of clusters is substantially equal.

12. The board mount power supply of claim 11, wherein inductors in at least one cluster of the plurality of clusters of inductors are set to a particular depth into one or both of the first plate and the second plate, wherein the particular depth of inductors of the at least one cluster is different than a depth into one or both of the first plate and the second plate of inductors of other clusters of the plurality of clusters.

13. The board mount power supply of claim 12, wherein at least one of the first plate and the second plate comprises a plurality of holes positioned at locations corresponding to positions of inductors for the plurality of clusters.

14. The board mount power supply of claim 13, and further comprising a board having a plurality of bumps that are positioned to fit into the plurality of holes of at least one of the first plate and the second plate, and wherein the plurality of bumps have heights that set depths of inductors of the plurality of clusters to desired depths into at least one of the first plate and the second plate.

15. A board mount power supply comprising:
a multi-phase inductor package including a plurality of clusters of inductors positioned between a first plate and a second plate, wherein each cluster of the plurality of clusters comprises a plurality of inductors in an intra-cluster arrangement such that a mutual magnetic flux density between the inductors within a cluster is substantially equal, and the plurality of clusters are positioned in an inter-cluster arrangement such that a mutual flux density between adjacent clusters of the plurality of clusters is substantially equal; and
a plurality of multi-phase controllers, each for an associated cluster of the plurality of clusters, each multi-phase controller configured to output a plurality of current signals at multiple different phases to the associated cluster to produce multi-phase power at an output of the multi-phase inductor package.

16. The board mount power supply of claim 15, wherein each cluster of the plurality of clusters comprises three inductors in a triangular arrangement, wherein the three inductors are substantially equally spaced apart from each other.

17. The board mount power supply of claim 15, wherein inductors in at least one cluster of the plurality of clusters of inductors are set to a particular depth into one or both of the first plate and the second plate, wherein the particular depth of inductors of the at least one cluster is different than a depth into one or both of the first plate and the second plate of inductors of other clusters of the plurality of clusters.

18. The board mount power supply of claim 17, wherein at least one of the first plate and the second plate comprises a plurality of holes positioned at locations corresponding to positions of inductors for the plurality of clusters.

19. The board mount power supply of claim 18, and further comprising a board having a plurality of bumps that are positioned to fit into the plurality of holes of at least one of the first plate and the second plate, and wherein the plurality of bumps have heights that set depths of inductors of the plurality of clusters to desired depths into at least one of the first plate and the second plate.

20. The board mount power supply of claim 15, further comprising a plurality of printed circuit boards transverse and attached to sides of the first plate and the second plate so as to enclose around the multi-phase inductor package, and wherein one or more of the plurality of multi-phase controllers are mounted to one or more of the plurality of printed circuit boards.

21. The board mount power supply of claim 20, further comprising wire connections between adjacent printed circuit boards of the plurality of printed circuit boards, the wire connections configured tie power rails and controls across the plurality of printed circuit boards.
